(19) United States
(12) Patent Application Publication
(10) Pub. No.: US 2007/0207369 A1
(43) Pub. Date: Sep. 6, 2007

(54) MINIATURE FUEL CELLS COMPRISED OF MINIATURE CARBON FLUIDIC PLATES

(76) Inventors: Benjamin Y. Park, Irvine, CA (US); Marc J. Madou, Irvine, CA (US)

Correspondence Address: ORRICK, HERRINGTON & SUTCLIFFE LLP, SUITE 1600, FOUR PARK PLAZA, IRVINE, CA, 92614-2554, US

(21) Appl. No.: 11/678,503

(22) Filed: Feb. 23, 2007

Related U.S. Application Data
(60) Provisional application No. 60/776,496, filed on Feb. 24, 2006.

(51) Int. Cl. H01M 8/02; H01M 2/08; H01M 4/94

(52) U.S. Cl. 429/38; 29/623.2; 429/35; 429/44

(57) ABSTRACT

An improved miniature fuel cell comprising fluidic plates having fluidic channel walls and a separator formed from high-temperature polymers. The fluid plates are heated at temperatures sufficient to convert the plates to conductive carbon structures. In one embodiment, the fluidic channel walls and separator are formed separately and bonded together with binder material that converts to conductive carbon during the heat treatment process and acts as a physical and electrical binder. The conductive carbon fluidic plates are assembled with a membrane, electrodes, catalyst support and gas diffusion layers, and gas inlets and outlets to form a fuel cell structure. The fuel cell structure is preferably sealed with an epoxy. The membrane is preferably formed from a hygroscopic material and is sized larger than the fluidic plates such that a portion of the membrane remains exposed to the environment exterior to the assembled fuel cell.

### CROSS-REFERENCE TO RELATED APPLICATIONS

This application claims the benefit of U.S. provisional application Ser. No. 60/776,496, filed Feb. 24, 2006, which is fully incorporated herein by reference.

### FIELD

The present invention relates to miniature fuel cells and, more particularly, to miniature fuel cells comprised of miniature carbon fluidic plates. BACKGROUND

The explosion of power-hungry mobile electronics has created the so-called “power gap.” Current mobile power solutions including Li-ion technology are not able to meet the increasing power demands of portable devices. This is exacerbated in future devices due to increasing integration of functionality and because transferring of large amounts of data increases power demands. One reason that battery technology cannot keep up with the tremendous rate of development of integrated circuit (IC) technology (Moore's Law) is because to increase battery capacity, methods of cramming more energy into a limited volume must be devised. In the case of IC technology, more and more functionality has been crammed onto limited area real estate by patterning smaller/finer features onto a silicon substrate.

One technology that has the promise of replacing batteries in mobile applications is the fuel cell. Fuel cells offer the following advantages over other mobile power sources: 1) Fuels used in fuel cells typically have much higher (approx. 10× according to reference) energy densities than their battery counterparts; 2) Instant replenishment of energy (instead of charging a battery for an extended amount of time, a fuel cell cartridge could be replaced.); 3) Fuel cells are clean and efficient; 4) To increase the power density of a fuel cell, one only needs to increase the surface to volume ratio within a fuel cell, which is a much simpler task than engineering new material chemistries.

Moreover, a microfabricated fuel cell design offers the following benefits: 1) The electrochemical reaction—heat transfer as well as mass transfer—are all surface phenomena; 2) Increased power density (due to high surface to volume ratio); 3) Low cost (due to less material cost); 4) High efficiency (due to high surface to volume ratio and the corresponding increase in triple phase boundaries); 5) Increased catalyst utilization (because there is more control over catalyst deposition); 6) Reduced system complexity; 7) Novel fuel cell applications; 8) It is easier to maintain a homogeneous environment within a small area; 8) Lower internal resistance (due to shorter conductive paths); 9) The balance of plant can be reduced, further reducing total weight and volume.

Even though efficient large-scale fuel cells (approx. 1-200 kW) have been developed and commercialized, it has proved much more difficult to create efficient miniature fuel cells. It is difficult to miniaturize traditional fuel cell designs (such as fuel cell stacks) to build portable fuel cells because the materials and manufacturing methods are just not available for microfabrication. One reason for this is because miniaturization processes have not been developed for many of the materials such as graphite used in large fuel cell designs. There have been attempts at replacing the high purity graphite bipolar separators that are used in conventional PEM fuel cells with other materials such as stainless steel, aluminum, titanium, and conductive plastics, but none of these materials have replaced carbon as the material of choice due to life time (due to corrosion) and contact resistance issues. Material issues are even more paramount in micro-electro-mechanical systems (MEMS)-based fuel cell designs because MEMS fabrication technology has traditionally been limited to a small palette of materials (silicon, metals, glass, some ceramics, etc.). Furthermore, since the miniaturization processes used in MEMS-based devices are mostly derived from IC technology, most processes are surface machining techniques. There has thus been a push towards planar monolithic MEMS fuel cell designs. Other non-planar fuel cell designs involve complicated fabrication schemes that are not manufacturing amenable.

As noted above, machined graphite is used in large-scale fuel cells as the bipolar plate material. In a fuel cell, the voltage from each cell is typically around 1 V depending on the losses occurring. Several cells need to be stacked in series to create a “useful” voltage. Bipolar plates are an optimal method of stacking cells. They act as a conductive separator between cells, separating the fuel from the oxygen. The fluidic channels of a bipolar plate serve to spread the gas across the entire cell. In the case of miniature fuel cells, graphite has not been the material of choice because of difficulties in machining and because it has traditionally been easiest to utilize IC and MEMS techniques to create small structures. As noted, most IC and MEMS techniques are planar surface micromachining techniques. Bulk micromachining techniques such as KOH etching of silicon can be used to create 3D bipolar plate designs, but these techniques are typically slow and uneconomical. Because of these reasons many in the field of miniature fuel cells support planar designs (many utilizing “flip-flop” connections). The planar designs have advantages in applications where the device that is to be powered is flat and has a large area (displays, etc.), but the fuel cells cannot be used in applications where no large area is provided. The disadvantage of these designs is that a fuel cell must be spread over a large area. An architecture using bipolar plates is preferred in order to create a compact volumetric package.

### SUMMARY

The embodiments described herein provide an improved miniature fuel cell comprised of miniature conductive carbon fluidic plates and methods that facilitate the formation of the miniature fuel cell. In one embodiment, which is described below as an example only and not to limit the invention, fluidic channel walls and separators are machined from high-temperature polymer sheets and bonded together to create fluidic plates. The fluid plates are then heated at temperatures sufficient to convert the plates into conductive carbon. The physical binders used to bond the fluidic channel walls and separators are preferably converted to conductive carbon and act as physical and electrical binders. The conductive carbon fluidic plates are then assembled with a membrane, electrodes, catalyst support and gas diffusion layers, and gas inlets and outlets to form a fuel cell structure.

In another embodiment, which is described below as an example only and not to limit the invention, the fluidic plates comprising fluidic channel walls and a separator, are formed as a unitary structure from high temperature polymers through molding, stamping and/or machining processes and then converted to conductive carbon. As an alternative to both embodiments, a gas diffusion layer comprising an electrode is bonded to the fluidic plate prior to the carbonization process.

In another embodiment, which is described below as an example only and not to limit the invention, a method of creating bipolar fluidic plates from carbon is used to create a compact volumetric package. The bipolar fluidic plates include fluidic channel walls formed on both sides of the separator.

Carbon has an advantage that it is the material used in larger fuel cells, thus much about its use in the fuel cell environment has been clarified. It is also inert in the fuel cell environment unlike metals, most of which corrode when used in a fuel cell. The noble metals that are inert within a fuel cell environment are expensive. Self-charring polymers are high-temperature polymers that easily convert into carbon while retaining their shape. In a preferred embodiment, machinable high-temperature polymers are used to create conductive carbon fluidic plates.

Alternatively, moldable high temperature plastics such as, e.g., polyurethanes, epoxies, and the like, are used to create conductive carbon fluidic plates.

In another embodiment, which is described below as an example only and not to limit the invention, a method is provided for converting mechanical binders into mechanical and electrical binders. Internal resistance may be minimized by binding all of the components of a fuel cell using a polymer binding agent. Treatment at high temperatures in an inert environment will convert the polymer binding agent into carbon, basically creating a single homogeneous structure. This method can provide lower internal resistance and mechanical robustness compared to the current electrical contact used in conventional proton exchange membrane (PEM) fuel cells where pressure is used to ensure an electrical connection.

In many stacked fuel cell architectures, pressure is applied to the top and bottom of the fuel cell to ensure adequate electrical connection between the layers and gaskets are used for sealing the outer edges of the fuel cell. Leakage is a problem in these designs. To avoid the problem of leakage, epoxy is preferably used as a permanent sealant for miniature fuel cells. Epoxy appears not to poison the fuel cell catalysts or significantly affect the membrane of a preferred embodiment of the fuel cell discussed below. Epoxy is preferably used to seal the entire fuel cell structure as a permanent sealant because of its resistance to acidic environments and its mechanical stability.

Water management tends to be an important issue in miniature fuel cell designs. In a preferred method, drying of the membrane tends to be prevented without the need of humidifying the dry hydrogen. The membrane is preferably formed from a hygroscopic material, such as, e.g., Nafion. Preferably, the membrane is larger than the fluidic plates of the fuel cell so that when the fluidic plates and membrane are assembled into the fuel cell, a portion of the membrane is left exposed to the environment surrounding the fuel cell allowing water to be supplied to the inner membrane by hydrating the exposed portion. The hygroscopic tendencies of the membrane are utilized to hydrate a portion of the membrane internal to the fuel cell by supplying moisture to a portion external to the fuel cell.

Further systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. It is also intended that the invention is not limited to the details of the example embodiments.

### BRIEF DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a flow chart depicting a method for forming a miniature fuel cell.

FIGS. 2A and 2B are plan views of fluidic channel walls used to form fluidic plates.

FIG. 3A is a perspective view of an exploded assembly of the fluidic channel walls and plates used to form fluidic plates.

FIG. 3B is a perspective view of an assembled fluidic plate used to form a fuel cell.

FIG. 4 is a perspective view of a bipolar fluidic plate of unitary construction used to form a fuel cell.

FIG. 5 is a perspective view of the fluidic plate post carbon conversion process.

FIG. 6 is a plan view of a membrane electrode assembly.

FIG. 7A is a plan view of a pair of fluidic plates, membrane electrode assembly, and gas inlets and outlets assembled into a fuel cell.

FIG. 7B is a section view of the fuel cell in FIG. 7A taken alone line 7B-7B in FIG. 7A.

FIG. 7C is a perspective view of the fuel cell in FIG. 5.

FIG. 8A is a photograph showing 1 cm×1 cm polymer squares and fluidic channel walls machined from polymer sheets.

FIG. 8B is a photograph of opposing fluidic channels walls polymer structures assembled to form a channel wall structure with a serpentine channel.

FIG. 9 is a photograph showing fluidic plate structures before carbonization.

FIG. 10 is a photograph showing a fluidic plate structures after carbonization. The fluidic plate structure shown is a three layer bipolar carbon fluidic plate structure.

FIG. 11 is a photograph showing two fluidic plate structures after carbonization to the left of a 1 cm×1 cm polymer square illustrating shrinkage of approximately 20% from carbonization.

FIG. 12 is a photograph showing a finished membrane electrode assembly.

FIG. 13 is a photograph of a final fuel cell assembly with hydrogen and oxygen gas tubes attached and wires attached with silver epoxy.

FIG. 14 is a graph illustrating the I-V curve and power of the fuel cell.

### DESCRIPTION

Referring in detail to the figures, the systems and methods described herein facilitate the construction of a miniature fuel cell comprised of miniature carbon fluidic plates using C-MEMS technology. C-MEMS technology allows relatively simple fabrication of miniature stacked bipolar proton exchange membrane (PEM) fuel cells. C-MEMS is a fabrication technique in which conductive carbon devices are made by treating pre-cursor structure to high temperatures (typically about 900° C. and higher, and in some instances about 2600° C. and higher) in an inert or reducing environment. Although some shrinkage occurs, the geometry is largely preserved during the carbonization process because the shrinkage is isometric. The details of the fabrication processes using SU-8 photoresist and polyimides are detailed in U.S. patent application Ser. No. 11/057,389 filed Feb. 5, 2005, and U.S. patent application Ser. No. 11/624,967, filed Jan. 19, 2007, respectively, which applications are incorporated herein by reference.

The results from the electrical characterization for C-MEMS carbon show that photoresist that has been treated to high temperatures (1000° C.) has a resistivity close to commercially available glassy carbon. For a thin bipolar plate, these resistivities should be more than sufficient for a working fuel cell platform.

C-MEMS technology allows fabrication of miniature fuel cell components using a material, i.e., carbon, already used in large-scale fuel cells. When applied to miniature fuel cells, C-MEMS technology offers the following benefits:

1. Novel bipolar design with carbon bipolar plates. While planar/monolithic designs are pertinent for applications where large areas are available, bipolar designs are much better suited for cases where a small three-dimensional package is preferred. A bipolar (instead of planar/monolithic) design with carbon bipolar plates allows small-sized volumetric packaging of miniature fuel cells.

2. Because the bipolar plate fluidics, gas diffusion layer, and catalyst support layer are all made of carbon, they can be integrated and fabricated into a single homogeneous structure. This reduces complexity and internal resistance while increasing mechanical robustness.

3. Increased surface area using nanomaterials and controlled microtexture (using a polymer binding agent). Techniques of increasing the surface area of C-MEMS have been developed and can be used to further increase surface area for fuel cell applications of C-MEMS structures.

4. Binding using C-MEMS materials for enhanced electrical contact. In C-MEMS technology, physical binding agents can also act as electrical binding agents because they are converted into carbon during the pyrolysis process.

5. Control over the carbon precursor allows materials engineering of the carbon itself.

6. Natural materials can be carbonized to create porous membranes with large surface/volume ratios and can be enhanced further with nanomaterials.

Self-charring polymers are polymers that create a layer of char (carbon) instead of melting or directly releasing large amounts of gas when treated to heat. When creating carbon structures from a polymer precursor, it is advantageous to retain as much carbon as possible from the hydrocarbon. Charring characteristics of a polymer are thus important for materials used for C-MEMS. Charring characteristics can be improved by cross-linking or chain stiffening of thermosetting polymers and, in general, charring polymers tend to have high melting, glass transition (Tg), and operating temperatures. High-temperature polyimides have the highest glass transition temperature (typically −400° C.) out of all of the widely available polymers and thus, polyimide is the preferred material for fabricating the miniature fuel cell.

Kapton® from Dupont is a commonly-used polyimide film that has no measurable melting temperature and has a glass transition temperature between 360° C. and 410° C. A film of Kapton® was pyrolyzed at 1000° C. Unlike the films of SU-8 negative photoresist, the pyrolyzed Kapton® film was not brittle and did not break into pieces when handled. The film exhibited excellent electrical conductivity after pyrolysis. PI-5878G is a wet-etchable high-Tg standard spin-on polyimide available as part of the SP series from HD Microsystems. The Tg of an applied film is 400° C. Initial experiments were performed with PI-5878G to test whether the material could be used to physically and electrically bind materials to create a homogeneous carbon structure. Initial tests using sheets of Kapton® and paper demonstrated that, after pyrolysis, the PI-5878G provided an excellent physical and electrical bond. The use of polyimide solids and PI-5878G is an attractive method for creating homogeneous carbon structures because, even before pyrolysis, the structure is a homogeneous polyimide structure.

Kapton® is not available in thick (>5 mil) films. For applications such as the miniature fuel cell described in the following text, thicker polyimide films are preferably used. Cirlex® from Dupont is a material consisting of 100% Kapton®. Sheets of Cirlex® consist of Kapton® sheets bonded using adhesive-less bonding technology.

Alternatively, high temperature plastics that convert to conductive carbon at high temperatures, such as, e.g., polyurethanes, epoxies, and the like, can be used to form fluidic structures for fuel cells.

Polyimide in the form of a 20 mil Cirlex® sheet and PI-5878G was selected to be used as the material for use in creating a microfluidic carbon plate for an initial prototype discussed in detail below. Although creation of a full fuel cell stack preferably includes the use of microfluidic bipolar plates, the initial prototype was fabricated using two monopolar plates.

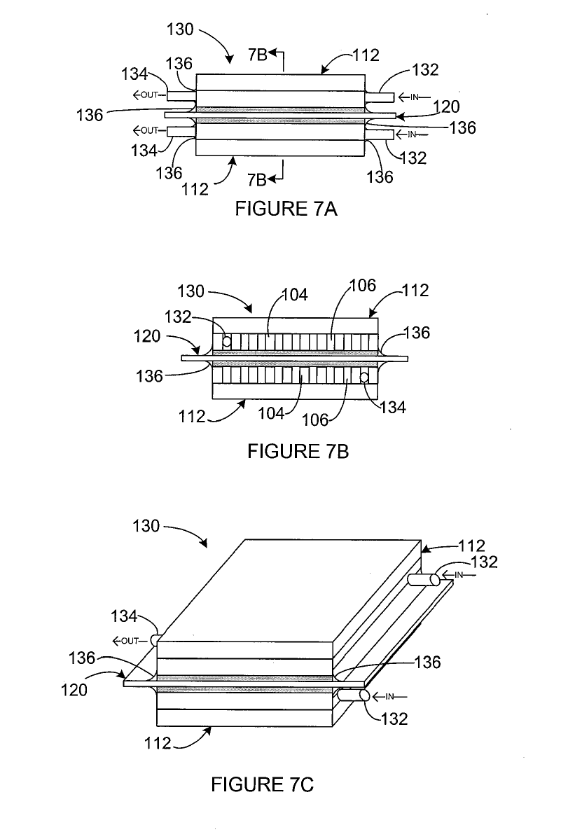

In an embodiment depicted in regard to the initial fuel cell prototype shown in FIGS. 7A-7C, the conductive carbon microfludic plate 112 (see FIGS. 5, 10 and 11) would be physically and electrically bonded with the gas diffusion layer, electrode, and catalyst support layer assembly 120 (see FIG. 6 and 12) during fabrication. This will result in forming a single integral carbon structure within the fuel cell 130.

In an alternative embodiment, the fabrication of the entire fluidic channel/electrode assembly, which includes the fluidic plates, electrodes, catalyst support layer and gas diffusion layer, as a homogenous unitary structure for improved mechanical (increased robustness, less sealing needed) and electrical (reduced internal resistance) characteristics. For example, an electrode comprised of a catalyst support layer as well as a gas diffusion layer could be bonded to the fluidic plate (to both sides of a bipolar fluidic plate) prior to pyrolysis. A gas diffusion layer which is preferably carbon paper (e.g., Toray carbon paper) could be combined with the fluidic plate (on either side of it) before pyrolysis and a catalyst ink could be applied to paper after pyrolysis. A single connected structure emerges from the pyrolysis process. As a result, the use of pressure need not be relied on to push the carbon components together for sealing and an electrical connection.

Another important design consideration to take into account when designing a fuel cell with small channel dimensions is that smaller channel sizes will increase the pressure drop within the channels. The total length of the channel should be short to insure that the pressure drop needed to drive the gas through the fluidics is not too great. The optimal channel size has been found to vary between approximately 100 microns and approximately 500 microns. Because flow channels with feature sizes of 500 microns can be easily machined instead of having to use photolithography, a channel size of 500 microns was used for the initial miniature fuel cell prototype.

In addition to proving feasibility of miniature carbon fluidic plates for use in miniature fuel cell stacks, the initial prototype utilized novel sealing and hydration methods for micro fuel cells. The novel hydration method provides for simple and efficient water management within micro fuel cells.

In many stacked fuel cell architectures, pressure is applied to the top and bottom of the fuel cell to ensure adequate electrical connection between the layers and gaskets used for sealing the outer edges of the fuel cell. Leakage is a problem in these designs. To avoid such leakage problems, epoxy was used as a permanent sealant for the initial miniature fuel cell prototype. Epoxy was used as a permanent sealant because of its resistance to acidic environments and its mechanical stability. The epoxy did not appear to poison the fuel cell catalysts or significantly affect the membrane within the fuel cell.

Water management is a important issue in miniature fuel cell designs. The method described herein is used to prevent drying of the membrane without the need for humidifying the dry hydrogen gas supplied to the fuel cell.. In a preferred embodiment, the membrane is formed from a hygroscopic material, such as, e.g., Nafion®, and is larger than the other components so that a portion of the membrane is left exposed to the outside environment. The hygroscopic property of Nafion® is utilized to hydrate the inner Nafion® membrane by supplying moisture to an external portion.

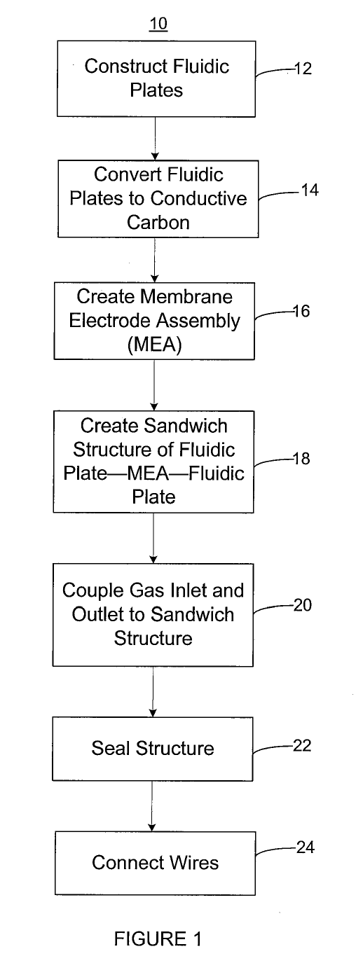

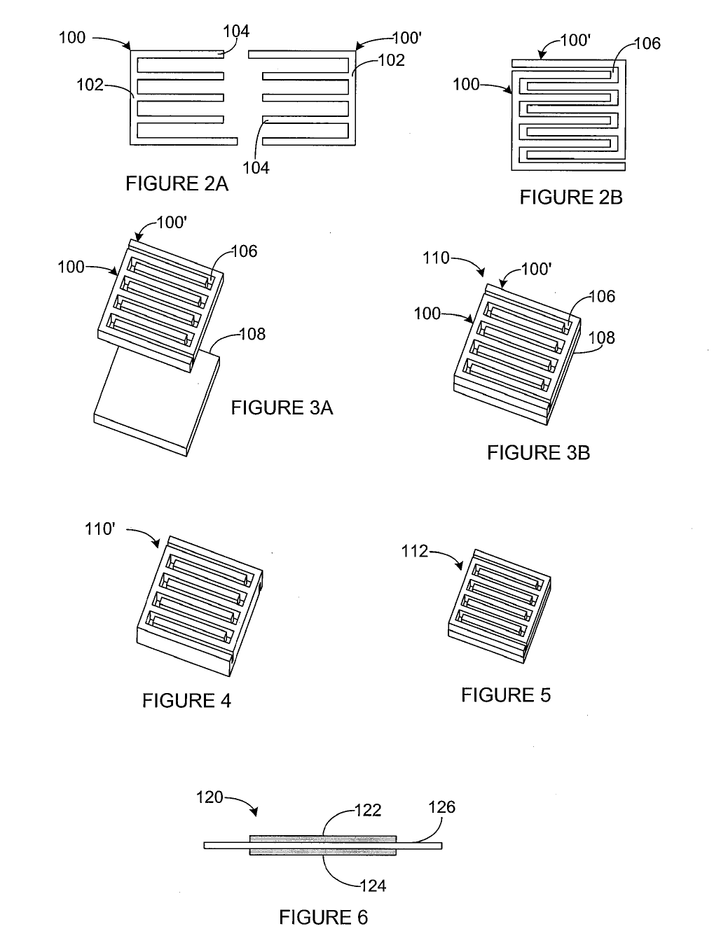

Referring to FIG. 1, a fabrication process 10 for forming a micro fuel cell is depicted. At step 12, fluidic plates are constructed from carbon pre-cursor material. In an embodiment used to form the initial prototype, fluidic channel walls 100 and 100′ (FIG. 2A and 2B) and separators 108 were formed by machining high-temperature polymer sheets and bonded together to create fluidic plates 110 (FIGS. 3A and 3B). Alternatively, the fluidic channel walls 100 and 100′ and separators 108 could be formed through molding or stamping processes. In an alternative embodiment, the fluidic plate comprising fluidic channel walls and a separator, are formed as a unitary structure from high temperature polymers through molding, stamping and/or machining. See, e.g., FIG. 4 in which a bipolar fluidic plate 110′ is formed as a unitary structure having fluidic channel walls formed on both sides of a separator.

At step 14, the fluidic plate structures 110 (or 110′) are converted into carbon structures 112 (FIG. 5) by heat treating the fluidic plate structures at temperatures sufficient to convert the structure to conductive carbon. A physical binder used to bond the fluid plates also preferably acts as an electrical binder; Next, at step 16, electrodes 112 and 114 are combined with a hygroscopic membrane 126, preferably constructed from Nafion®, to create a membrane electrode assembly (MEA) 120 (FIG. 6); The MEA 120 carbonized fluidic plates 112 are assembled, at step 18, as a fuel cell sandwich structure 130 and gas inlets 132 and outlets 134 are coupled to the structure 130 at step 20 (FIGS. 7A-7C). As an alternative, a gas dissusion layer comprising an electrode can be bonded to the fluidic plate 110 prior to pyrolysis; At step 22, epoxy 136 is used to seal the entire fuel cell structure 130; Wires are affixed to the structure 130 at step 24. A detailed discussion of these steps in regard to forming an initial prototype structure is provided below.

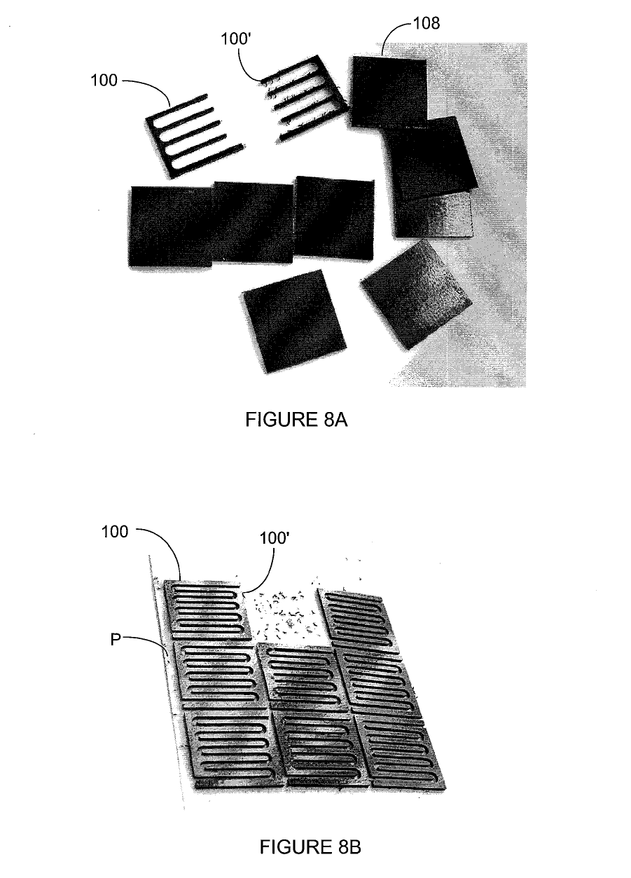

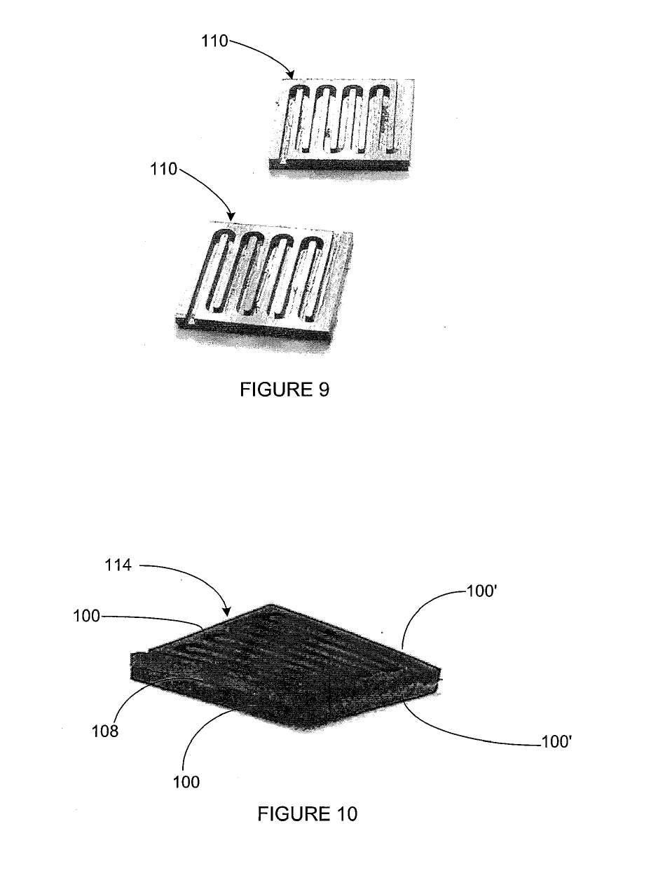

Fluidic plate construction: Referring to FIGS. 2A, 2B, 8A and 8B, high-temperature polymer sheets, such as, e.g., polyimide sheets were finely machined to form fluid channel walls 100 and 100′. In fabricating the prototype, Cirlex® sheets, which are made by bonding several Kapton® sheets to create a thicker sheet, were machined to form the fluid channels walls 100 and 100′. The Cirlex® sheet was placed on a polyimide P adhesive to hold the machined pieces in place after and while machining (see FIG. 8B). 500 micron thick Cirlex® sheets were machined with 500 micron diameter end mills in a T-Tech circuit board milling tool to create the fluidic channel walls. (Past literature suggests 100 microns-500 microns is an optimal size that allows gas to evenly diffuse without the channels becoming blocked with water. Although 500 micron sheets were used for the initial prototype because of ease of handling, thinner sheets can provide lower internal resistance as well as possibly maximizing mass transport. However, thinner sheets tend to be difficult to handle and when carbonized, cracked too easily when handled manually.)

As depicted, a serpentine flow pattern was used, but other flow patterns such as interdigitated or spiral interdigitated patterns may be used. Fluidic pieces 100 and 100′ as well as blank/bare 1 cm×1 cm squares 108 (FIG. 8A) were cut out.

The machined fluidic pieces 100 and 100′, which include a base 102 and fingers or channel walls 104 extending there from, are bonded together with a high-temperature polymer (preferably the same type of polymer as the machined plastic). The fluidic pieces 100 and 100’ are kept aligned with each other by keeping them adhered to an adhesive material. The fluidic pieces were carefully transferred to polyimide tape P to avoid melting of the adhesive material as the binder material is cured.

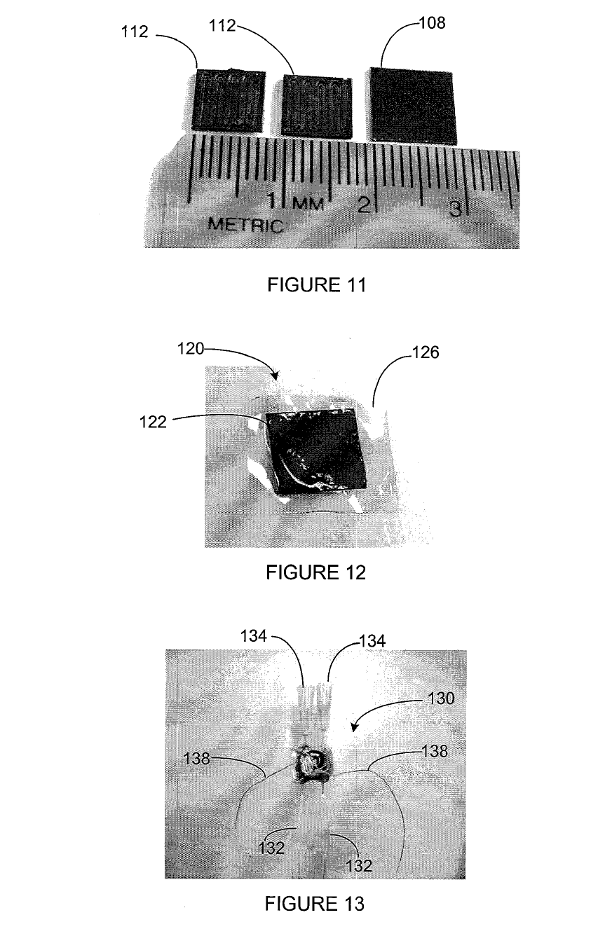

Blank squares 108 are used as gas separators. Squares of 5 mil thick Kapton have been used as separators, but thicker Cirlex® is preferred due to the mechanical robustness. Although the fluidic pieces 100 and 100′ were bonded, as shown in FIGS. 3A, 3B and 9 to one side of the blank squares 108 for fabrication of the prototype, the pieces 100 and 100′ could have been bonded to the top and bottom of the blank squares 108 to create bipolar fluidic plates for the fuel (hydrogen, methanol, etc.) and the oxidant (air, oxygen, etc.). Such three-layer bipolar plates 114 have been created as depicted in FIG. 10 using the methods described herein.

The bonding material used to bond the fluidic pieces 100 and 100′ to the blanks 108 is preferably a polyimide. For the prototype the bonding material used was PI5878G from HD Microsystems. Prior to applying the bonding material, the fluidic pieces 100 and 100′ and blanks 108 were cleaned with successive washes of isopropanol, acetone, and again, isopropanol. After drying of the parts with dry nitrogen gas, the PI5878G polyimide was applied with a cotton swab. After application, the bonding material needs to be cured by ramping up the temperature and holding it there for a predetermined amount time using a heating element. In this instance, the PI5878G was cured by ramping the temperature at a rate slower than 4° C./min to 200° C. on a hot plate. The temperature was held at 200° C. for 1 hour. The hot plate was then turned off and the polyimide was left on the hot plate to allow to cool slowly. The polyimide tape was then removed because the fluidic pieces 100 and 100′ and blank 108 were now bonded in place to form a fluidic plate 110 as shown in FIG. 3B. FIG. 9 shows a photograph of the fluidic plate structures 110 before carbonization.

The bonded structure 110 was then treated to high temperatures in an inert environment to convert the entire structure into conductive carbon. A heavy object that survives high temperature, such as steel weight, was placed on top of the structure 110 to avoid warping. The entire structure 110 was pyrolyzed in a two-step process in a forming gas (5% hydrogen, 95% nitrogen) atmosphere using an open-ended quartz furnace. The temperature was ramped from room temperature to 300° C. in 12 minutes. The heating element was turned off and the hot furnace was left for 30 minutes in order to fully cure and heat treat the polyimide. After 30 minutes, the furnace temperature was 220 degrees. The temperature was ramped to 900° C. in 60 minutes and left at 900° C. for an hour to fully convert the polyimide into carbon. The furnace was then turned off and let to slowly cool to room temperature.

For increased conductivity, the temperature could be ramped up to a temperature greater than 900° C. and in some instances to a temperature greater than 2600° C., e.g., when graphite is desired.

It is important to note that there is some shrinkage in the final structure. About 20% shrinkage in length and width was observed between the fluidic plate 110 prior to carbonization (FIG. 3B) and the fluidic plate 112 post carbonization (FIG. 5). FIG. 11 is a photograph of two fluidic plates 112 post carbonization to the left of a 1 cm×1 cm Cirlex® square 108. The structures shown in FIG. 9 were carbonized to create the carbon fluidic plates shown in FIG. 11. The shrinkage of approximately 20% can be seen.

Membrane electrode assembly (MEA) construction: A Nafion sheet (Nafion 115) was used as the membrane 126 shown in FIG. 6 for the initial prototype. The membrane 126 with a thickness of ˜5 mils is preferably cut to a size that is slightly larger than the carbonized fluidic plates 112 size. Electrodes 122 and 124 cut to the size of the carbonized fluidic plates 112 are pressed into each side of the membrane 126.

In the instance of the prototype, commercial fuel cell electrodes 122 and 124 are cut to the size of the carbonized fluidic plate 112. The commercial fuel cell electrodes are preferably comprised of carbon paper (acting as the gas diffusion layer) with platinum catalyst loaded on one side. The electrodes come pretreated with teflon to allow water to pass through easily. The catalyst only needs to be replaced with PtRu on the anode side to create a direct methanol fuel cell. For the initial prototype, an electrode with 1 mg/cm2 loading, 20 wt. % Pt/Vulcan XC-72 was used.

5% Nafion solution is brushed on the side of the electrode that has the platinum catalyst. The Nafion is activated by a series of heated baths (all at 80° C.): DI water at for 1 hour, 30% Hydrogen Peroxide for 1 hour, ˜10M Sulfuric Acid (1:1 dilution of pure H2SO4 and DI water) for 1 hour, and finally a short rinse in DI water. The Nafion is preferably stored in water until fabrication of the MEA.

The electrodes 122 and 124 are placed on either side of the Nafion sheet 126 and pressed into the Nafion sheet 126. Although a pressure of ˜2 Mpa is recommended, a C-Clamp was used to press the electrodes into the Nafion sheet. Everything was heated under glassware with a water soaked fabric in order to prevent drying out of the Nafion. The Nafion and the electrodes were ramped to 90° C. for 1 hour, to 130° C. for 30 minutes and the C-Clamp was tightened at 130° C. and left at 130° C. for 5 minutes. The hot plate was shut off and let to cool slowly to room temperature. FIG. 12 shows a photograph of the finished MEA 120.

Integration into a miniature fuel cell: Turning to FIGS. 7A-7C and 13, the carbonized fluidic plates 112 were aligned with the MEA 120. The fluidic plate 112—MAE 120—fluidic plate 112 assembly 130 was held together with pressure using a C-Clamp. Paraffin was used between the C-Clamp and the structure to prevent breakage and because paraffin is easily removed.

Alternatively, an electrode comprised of a catalyst support layer as well as a gas diffusion layer could be bonded to the fluidic plate (to both side of a bipolar fluidic plate) prior to pyrolysis. A gas diffusion layer which is preferably carbon paper (e.g., Toray carbon paper) could be combined with the fluidic plate (on either side of it) before pyrolysis and a catalyst ink could be applied to paper after pyrolysis. A single connected structure emerges from the pyrolysis process.

Syringe needles 132 and 134 were inserted into the fluidic entrances and exits in order to provide an interface to external gas or fluidic sources. Epoxy 136 was used to seal and hold the needles in place.

Two-part epoxy was used to seal the fuel cell 130. It was applied liberally, but the entire Nafion 126 sheet was not covered. The Nafion sheet 126 not covered with epoxy can be exposed to water/moisture and the water can diffuse within the fuel cell 130.

The carbon surface that is exposed serves as the electrical contact area. Wires 138 can be attached to this area using conductive silver epoxy for ease of connection.

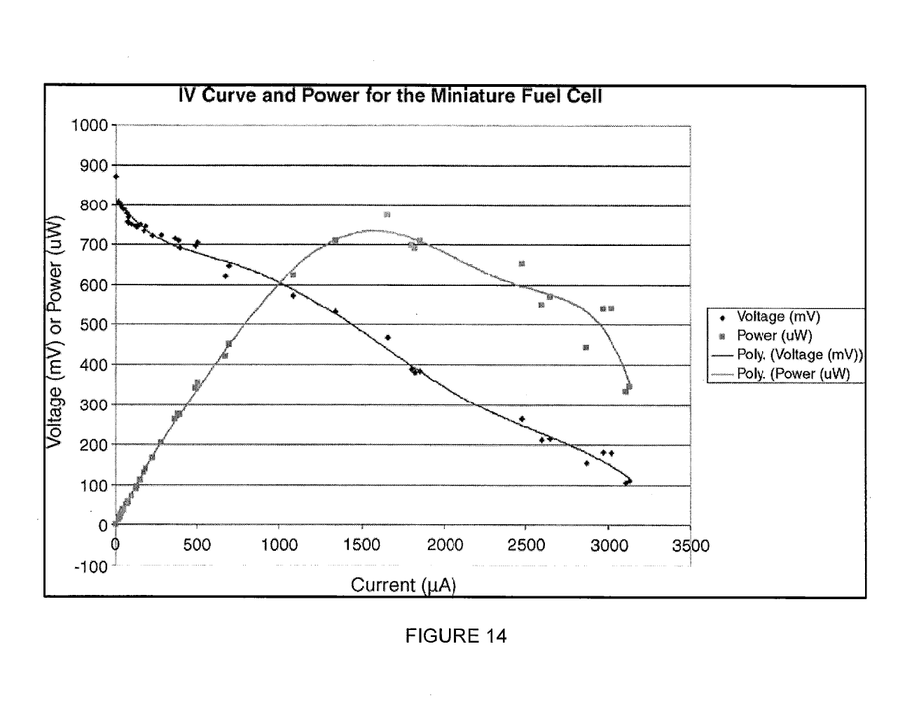

An open-circuit voltage of 871 mV was measured when using a crude electrolyzer setup (platinum electrodes in a sodium sulphate solution) at room temperature. The closed-circuit current draw of the fuel cell stabilized at 3.11 mA (with a voltage of 110 mV). The IV curve and power of the fuel cell is shown in FIG. 14. The maximum power output was 0.773 mW. Because the fuel cell area is 0.64 cm2, the areal power output is 1.21 mW cm-2. From the IV curve, the internal resistance of the fuel cell was calculated to be approximately 210 Ohms. Using the same electrode and catalyst loading but at 90° C. and with a pressure of 101 kPa (1 atm) for each gas, a power peak of 6.7 mW cm-2 was measured. The areal power output for the C-MEMS fuel cell 130 was expected to be lower than 6.7 mW cm-2 because of the low temperature of operation and the extremely small area of the fuel cell (˜500 times smaller than typical portable fuel cells). The small area is also the cause of the large internal resistance. This internal resistance can be minimized by using thinner Nafion® membranes. It was not determined whether the fuel cell was operating at maximum efficiency. It is possible that the open-circuit voltage will increase with a higher pressure fuel/oxygen flow. In future tests, testing with a pressurized hydrogen and oxygen source will be performed at 80° C.

As provided herein, a miniature fuel cell has been fabricated using a novel fluidic plate made by pyrolysis of machined polyimide. Epoxy sealing has been used to seal the fuel cell and a water management technique of exposing the Nafion membrane has been used. The prototype fuel cell presented herein is believed to be the world's smallest PEM fuel cell that utilizes carbon fluidics.

Advantages of the miniature fuel cells comprised of miniature carbon fluidic plates include 1) a novel bipolar (instead of planar/monolithic) design with carbon bipolar plates will allow small-sized volumetric packaging of miniature fuel cells; 2) because the bipolar plate fluidics, gas diffusion layer, and catalyst support layer are all made of carbon, they can be integrated and fabricated into a single homogeneous structure. This reduces complexity and internal resistance while increasing mechanical robustness; 3) binding using C-MEMS materials for enhanced electrical contact (In C-MEMS technology, physical binding agents can also act as electrical binding agents because they are converted into carbon during the pyrolysis process); and 4) simple and effective sealing and water management.

Future advantages will include 5) increased surface area using nanomaterials and controlled microtexture (using a polymer binding agent); 6) control over the carbon precursor allows materials engineering of the carbon itself, 7) passive and active designs available; 8) can use natural materials for porous membranes with large surface/volume ratio and can be enhanced further with nanomaterials

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit of the disclosure. Furthermore, it should also be understood that the features or characteristics of any embodiment described or depicted herein can be combined, mixed or exchanged with any other embodiment.

What is claimed:

1. A method of making a fuel cell comprising:
forming first and second fluidic plates from polymer material;
heat treating the first and second fluidic plates in an inert environment at a temperature sufficient to convert the polymer material into conductive carbon;
assembling the first and second fluidic plates with a membrane and first and second gas diffusion layers sandwiched there between,
coupling gas inlets and outlets to the first and second fluidic plates, and
sealing the assembled structure comprising first and second fluidic plates, membrane, first and second gas diffusion layers, and gas inlets and outlets.

2. The method of claim 1 wherein the sealing step includes applying an epoxy to seal the assembled structure.

3. The method of claim 1 wherein the fluidic plates are bipolar.

4. The method of claim 1 wherein the fluidic plates comprise fluidic channel walls and a separator.

5. The method of claim 4 wherein the forming step includes separately forming the fluidic channel walls and separator and bonding the channel walls and separator to form the fluidic plate.

6. The method of claim 5 wherein the heat treating step includes converting the material used to bond the channel walls and separator to conductive carbon.

7. The method of claim 1 wherein the assembling step includes bonding the first and second gas diffusion layers to the first and second fluidic plates prior to the heat treatment step.

8. The method of claim 7 wherein the first and second gas diffusion layers include an electrode.

9. The method of claim 7 wherein the first and second gas diffusion layers are carbon paper.

10. The method of claim 1 further comprising the step of applying a catalyst to the first and second gas diffusion layer.

11. The method of claim 10 wherein the first and second gas diffusion layers include an electrode.

12. The method of claim 10 wherein the first and second gas diffusion layers are carbon paper.

13. The method of claim 1 wherein the assembling step includes a portion of the membrane to the environment exterior to the assemble structure.

14. The method of claim 1 further comprising the step of hydrating the membrane in the interior of the assembled structure by exposing a portion of the membrane exterior to the assembled structure to water.

15. The method of claim 14 wherein the membrane is formed from a hygroscopic material.

16. The method of claim 1 further comprising the step of externally hydrating the membrane.

17. A fuel cell comprising:
first and second fluidic plates formed of a polymer material converted to conductive carbon, and
a hygroscopic membrane interposing the first and second fluidic plates and have a portion exposed to the exterior of the full cell.

18. The fuel cell of claim 17 further comprising an epoxy seal applied to the exterior of the fuel cell.

19. The fuel cell of claim 18 wherein the first and second fluid plates comprise fluidic channel walls and a separator.

20. The fuel cell of claim 19 wherein the fluidic channel walls and separators are bonded together to form the first and second fluidic plates with a material converted to conductive carbon.

21. The fuel cell of claim 17 wherein the first and second fluidic plates are bipolar.

22. The fuel cell of claim 17 further comprising first and second gas diffusion layers interposing the membrane and the first and second fluidic plates.

23. The fuel cell of claim 22 further comprising a catalyst material applied to the first and second gas diffusion layers.

24. The fuel cell of claim 22 wherein the first and second gas diffusion layers include first and second electrodes.

25. The fuel cell of claim 22 wherein the first and second gas diffusion layers are formed from carbon paper.
